(19) United States
(12) Patent Application Publication
(10) Pub. No.: US 2015/0042669 A1
(43) Pub. Date: Feb. 12, 2015

(54) ROTATING DISPLAYED CONTENT ON AN ELECTRONIC DEVICE

(71) Applicant: NVIDIA Corporation, Santa Clara, CA (US)

(72) Inventors: Mark Van Nostrand, Dripping Springs, TX (US); Sarika Bhimkaran Khatod, Bangalore (IN)

(73) Assignee: NVIDIA Corporation, Santa Clara, CA (US)

(21) Appl. No.: 13/962,294

(22) Filed: Aug. 8, 2013

(51) Int. Cl. G06T 1/60

(52) U.S. Cl. CPC G06T 1/60
USPC 345/545

(57) ABSTRACT

The description is directed to systems and methods for rotating the image displayed on an electronic device. The data associated with the displayed image is stored in memory locations, typically in a matrix of rows and columns of pixel data. A position sensor detects the rotational position of the device, and this position is used to control the manner in which data is read from the image model. Specifically, data is read from the image model using a read sequence that varies with the detected position of the device, thereby eliminating the need for making additional copies of the image data to account for device rotation.

### BACKGROUND

The ability to rotate displayed content is now a standard feature in portable electronic devices. Rotation typically occurs in response to detecting a change in the physical orientation of the device. In order to render upright images in such an environment, existing systems typically make additional copies in memory to ensure that the correct pixels are read and then written to the appropriate portions of the display. Making these additional copies takes time, adds complexity, increases power consumption and can otherwise negatively affect performance.

### BRIEF DESCRIPTION OF THE DRAWINGS

FIGS. 1 and 2 depict an example of an existing method for handling rotation of displayed content.

FIG. 3 illustrates the storage of image models in memory as row-column matrices of pixel data.

FIG. 4 is a block diagram illustrating an electronic device that implements display rotation in accordance with the present disclosure.

FIG. 5-8 illustrates the use—in accordance with the present description—of different spatial read sequences for reading/fetching pixel data from an image model, each of which are associated with a different orientation of the electronic device on which output is to be displayed.

FIG. 9 is a block diagram illustrating a re-ordering process that can be employed in accordance with the present description when pixel data is retrieved in tiled/block formats.

FIG. 10 is a flow chart of an example method for rotating displayed content.

FIG. 11 is a schematic depiction of an electronic device that is operative to rotate displayed content in accordance with the present description.

### DETAILED DESCRIPTION

This description is directed to novel systems and methods for rotating displayed content on an electronic computing device in response to changes in the physical orientation of the device, and/or in response to user input. As is known in the art, image data typically is stored in memory as matrices of rows and columns of pixels. The data for a given image (e.g., a frame of video output) may be referred to as the “image model.” In existing systems, the pixel data for a given image model is fetched (i.e. read) in a static and unchanging spatial read sequence relative to the stored matrix: the fetch begins at the leftmost column and topmost row (the term “read origin” is used herein to denote the location on the image model from which pixels are first fetched for a given display frame) and then proceeds row-by-row until the last row at the bottom of the image model is fetched. Alternatively, a block scheme can be employed in which pixels are fetched in groups. But in such block systems, as in the pixel-by-pixel fetch scheme, a static unchanging read sequence is employed relative to the matrix in which the image model is stored (typically beginning with the upper left portion of the image model/rendered scene).

Pixels are written to the display of the computing device in the sequence in which they are retrieved from memory, and writing typically occurs in a fixed spatial writing sequence relative to the display itself. Specifically, writing begins at a particular corner of the display, which will at times be referred to herein as the “write origin”. Writing then proceeds left-to-right, row-by-row until the entire display has been written top to bottom. This fixed writing sequence requires that pixels be read/retrieved in an order that is determined by the orientation of the display device. For example, one orientation might require that pixels corresponding to the top left of the scene/frame be retrieved first; another orientation might require that the bottom right be retrieved first.

Since existing systems employ both a fixed reading and a fixed writing spatial sequence, they need, for a particular orientation of the device, to create an additional copy of the image model in memory that is rotated to account for the device orientation. In contrast, the present systems and methods employ a spatial read sequence for reading image data that dynamically varies in response to the detected orientation of the device. This allows images to be appropriately rendered without having to make additional modified copies of the image model in memory.

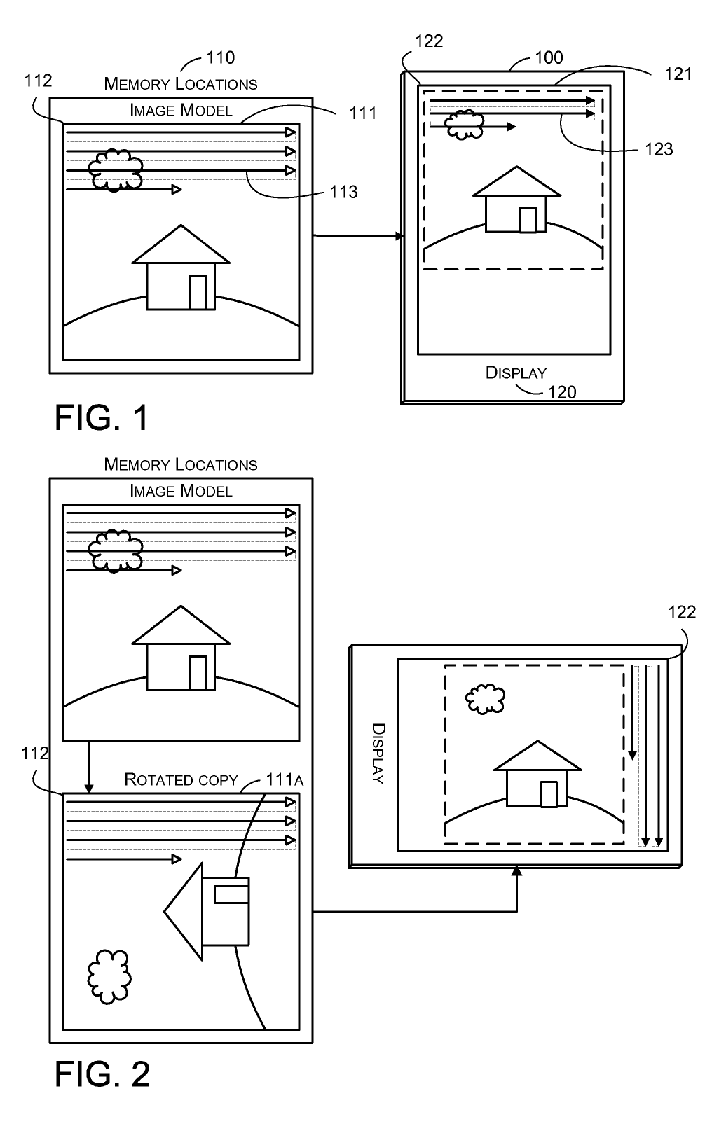

Turning now to the figures, FIG. 1 shows an example of how the image model is fetched and rendered on the display of the device while in a default portrait orientation. Specifically, the figure shows a portable electronic device 100 including a display 120 and memory 110, which includes multiple locations in which image data may be stored. The image data for rendered scene 121 (where the “rendered scene” represents the displayed output for a frame of image data) is stored in memory as image model 111. During retrieval the image model is fetched starting at read origin 112 using spatial read sequence 113 (row-by-row fetch scanning left to right) and written to the display starting at write origin 122 using spatial write sequence 123 (row-by-row rendering scanning left to right).

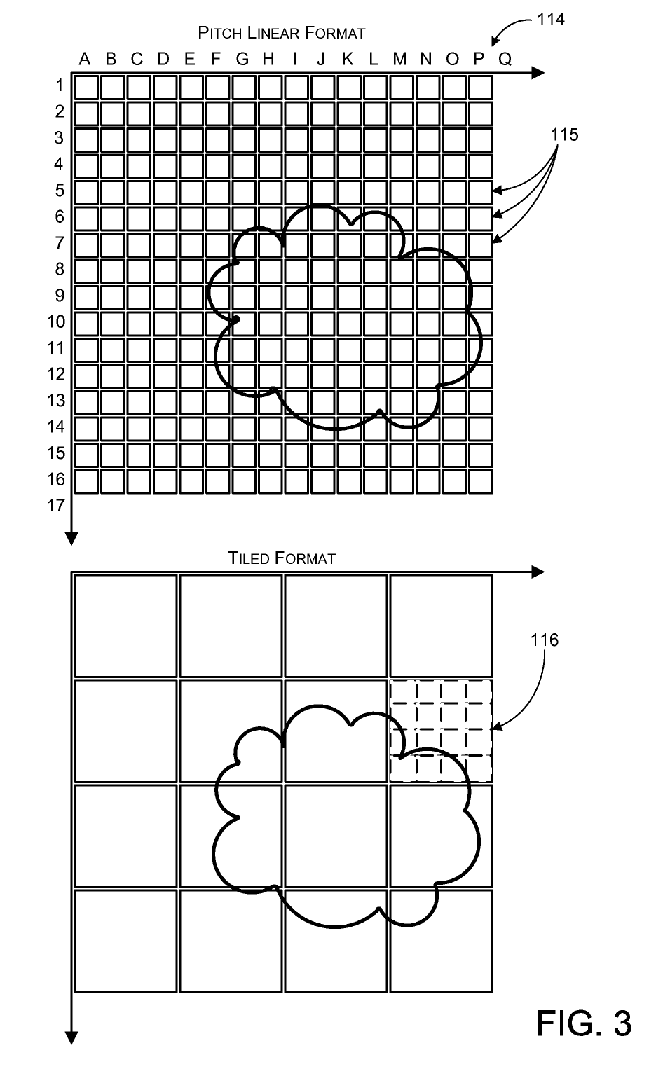

In the case where the device is physically rotated, FIG. 2 illustrates how electronic device 100 from FIG. 1 responds to the change in orientation. It will be noted that relative to a user's perspective, the write origin has changed position (to the upper right from the user's perspective) while the read origin on the image remains the same (i.e., remains at the upper left corner of the matrix to be read). The figure shows image model 111 being duplicated in memory to create rotated image copy 111A to compensate for the movement of the write origin. The rotation is such that when the image copy is fetched it will be rendered to the display, starting at write origin 122, so as to produce the rendered scene in an appropriate upright orientation from the user's perspective. It should be noted that the read origin and spatial read sequence does not change in the present existing system (i.e., reading starts from the upper left corner of the image model matrix and proceeds row-by-row scanning left to right). As shown in more detail in FIG. 3, the information defining the image model is stored in matrix 114 of rows and columns of pixel data 115, i.e. rows 1, 2, 3, etc. and columns A, B, C, etc. When pixel data is retrieved one pixel at a time, the retrieval system may be described as operating in “pitch mode”. Alternatively, various “block modes” may be employed, in which pixels are retrieved in groups that are defined by multiple partial rows and/or partial columns, such as pixel tile 116. Regardless of whether operating in pitch or block mode, the read sequence in typical existing systems is static and unchanging and always begins with the upper left and moves left to right until reaching the bottom right corner of the image model.

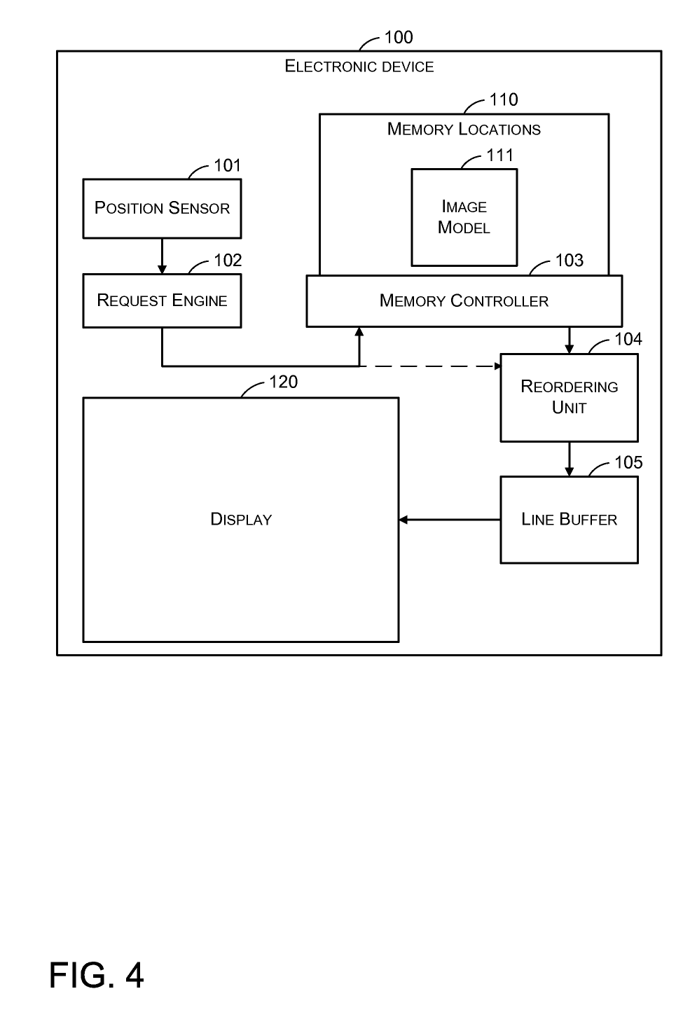

Turning now to FIG. 4, the figure shows an electronic device in which pixels are retrieved in a spatial read sequence that varies based upon the detected orientation of the electronic device. Electronic device 100 typically will include some type of memory system, which may include one or more of the following: (1) processor registers; (2) hierarchical cache memory; (3) main memory; (4) secondary storage, such as hard disks and the like; (5) etc. More specifically, the memory system includes memory locations 110 which can be used to store image model data in matrix form, such as image model 111. Additionally, in this example the electronic device includes position sensor 101 to determine the orientation of the device, typically through the use of an accelerometer, gyroscope, user input or any other appropriate method. Request engine 102 initiates the transfer of image data out of memory by specifying a spatial read sequence associated with the detected orientation of the device. That information is fed to memory controller 103, which may be a host adapter, which manages the process of fetching the image model using the specified spatial read sequence and sending the retrieved image data to the display, typically through intervening components or functional blocks. If the data is retrieved in groups of pixels (e.g. tiled format), reorder unit 104 rearranges the individual pixels of each group to match the spatial read sequence used by the memory controller on the entire scene. From there the resequenced and reordered image data is sent to line buffer 105, a functional block that may include a plurality of line buffers acting as a temporary holding location for image data before being fed to display 120 in a First In, First Out (FIFO) process, a process where data is written in, at least roughly, the same order it was read in. In should be understood that these steps can be variously implemented in hardware and/or software and may delegate a task to a different component in another embodiment of this description. Typically, although image data may be retrieved in pitch or block format, data is written to the display in pitch mode, i.e., pixel-by-pixel.

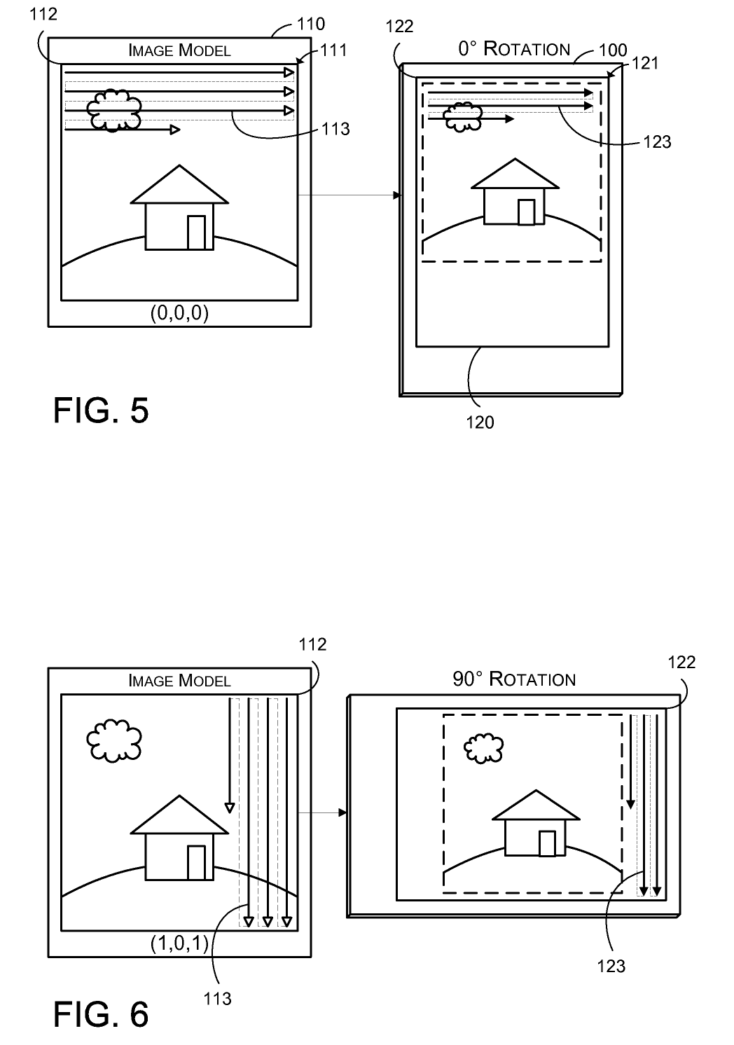

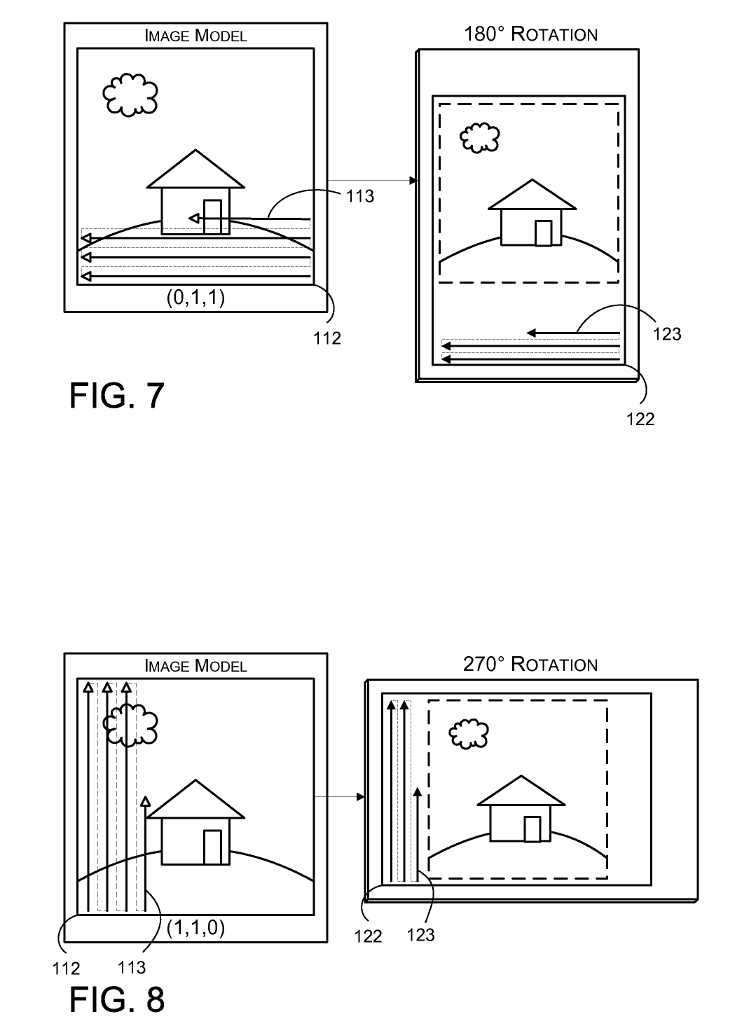

The solution contemplated herein makes use of four potential spatial read sequences, i.e., sequences that the memory controller uses to retrieve data from the image model. The four potential spatial read sequences retrieved by the memory controller are shown on the left side of FIGS. 5-8. The figures respectively correspond to scenarios in which the device has been rotated by 0 degrees (FIG. 5), 90 degrees (FIG. 6), 180 degrees (FIGS. 7) and 270 degrees (FIG. 8). Each figure shows image model 111 along with corresponding read origin 112 and spatial read sequence 113. As will be described in more detail below, the read origin and spatial read sequence varies depending upon the detected orientation of the device.

In one implementation, three Boolean control signals are used to instruct the memory controller how to retrieve data from the image model. The values of these control signals for each of the four rotation scenarios are indicated below the image model in each figure. The three signals may be referred to as (1) SCAN_COLUMN; (2) H_DIR; and (3) V_DIR. SCAN_COLUMN specifies whether pixels or pixel groups are to be read from the image model row-by-row or column-by-column. H_DIR indicates whether retrieval will begin at a topmost or bottom most portion of the frame of image data. V_DIR indicates whether retrieval will begin the leftmost or rightmost portion of the frame of image data.

Moving to the right side of FIGS. 5-8, the figures show four representations of display 120 on electronic device 100 from each orientation, orthogonal to each other, along with corresponding write origin 122 and spatial write sequence 123. In each representation it should be noted that the read and write origins are in the same location relative to rendered scene 121 due to the FIFO nature of the retrieval process. FIGS. 5-8 show that regardless of how the orientation of electronic device 100 changes (along with the position of the write origin), the read origin of the image model changes to correspond to the new position, preserving the uprightness of the rendered scene relative to the user. Alternately, the solution may be characterized as varying the order in which data is retrieved from the image mode in response to changes in orientation of the electronic device. In other words, pixel data is retrieved from the matrix model in an order/sequence that varies depending on the detected orientation of the device.

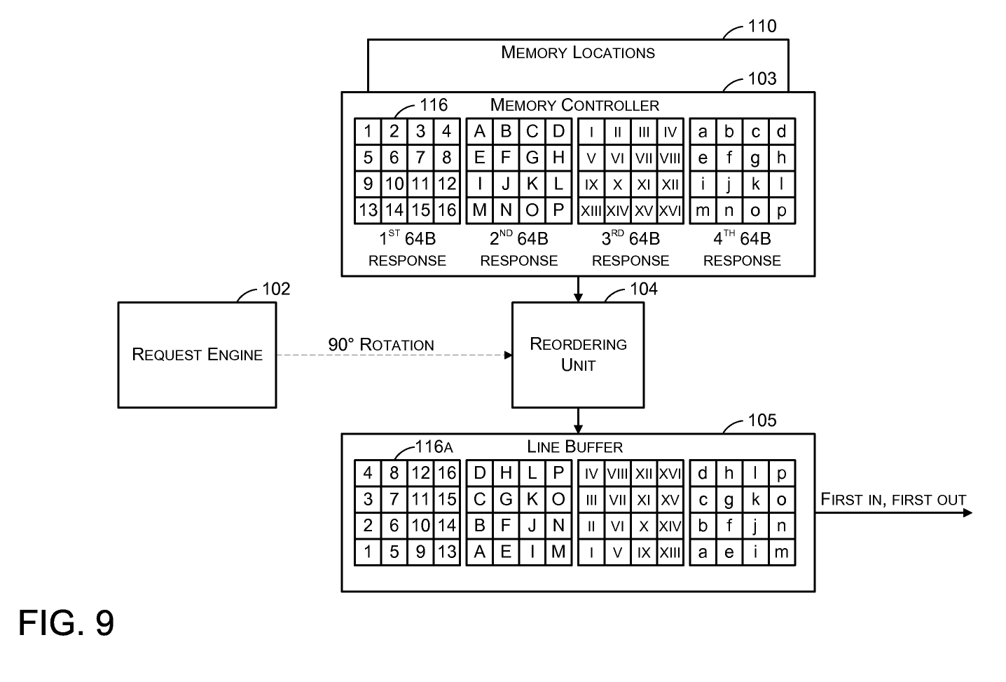

The pixels in fetched pixel data may need to be re-ordered to the pitch mode writing to the display. FIG. 9 depicts an example method of rotating a series of four pixel tiles 116 retrieved from memory locations 110 by memory controller 103. Those tiles are fed to reordering unit 104, along with the spatial read sequence from request engine 102, to be individually processed to match the orientation of the overall scene being rendered and fed to line buffer 105. In the case of a 90° rotation, pixel tile 116A represents an appropriately rotated pixel tile which will be split up and fed into four separate line buffers to prevent the memory controller from having to re-fetch pixel data when the display moves on to the second, third or fourth line of a row of tiles. Reordering can be considered to have taken place on the pixel-by-pixel case despite no changes having occurred as a rotated pixel is equivalent to its original orientation. While RGB formats will work with a single line buffer for each line of pixel data, if a YUV color space format is in use each line will have access to either two or three line buffers depending on the format's requirements. It should be noted that this process may occur inside another component, such as the memory controller in another embodiment of the disclosure.

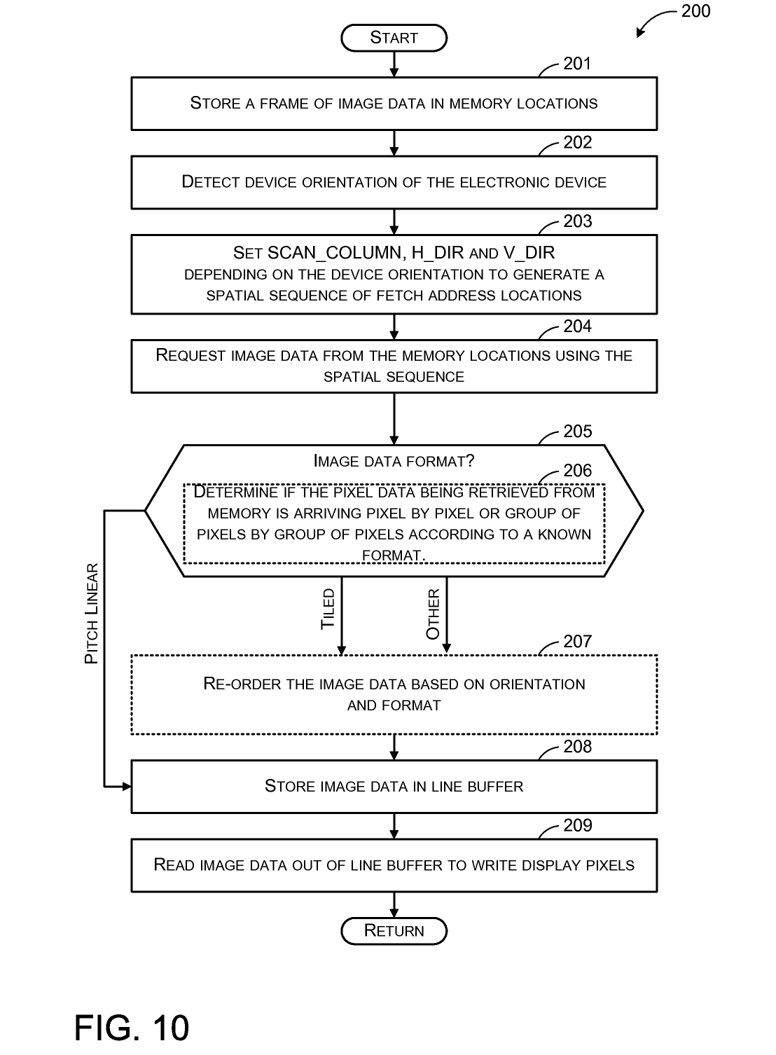

FIG. 10 is a flow chart representing an example of method 200 of rotating rendered scene 121 according to a detected orientation.

At 201 of method 200 a scene of image data is stored in memory locations 110 on electronic device 100. That scene is referred to as image model 111.

At 202 of method 200 position sensor 101 detects the physical orientation of the device and feeds that information to request engine 102.

At 203 of method 200 the request engine generates spatial read sequence 113 of fetch address locations by assigning appropriate values to SCAN_COLUMN, H_DIR and V_DIR based on the detected device orientation in order to match the read origin relative to the image model to the write origin as perceived by the user. It sends those values to memory controller 103 to initiate memory retrieval and to reorder unit 104 for reasons described below.

At 204 of method 200 the memory controller receives the request and retrieves the image data in the spatial read sequence described by the values provided. In other words, the data is retrieved from the image model in an order that varies based on the detected device orientation.

At 205 of method 200 the format of the data being retrieved from memory is determined process 206. If it is fetched pixel-by-pixel the data passes through the reorder unit without change, but any other format is reordered before reaching line buffer 105.

At 207 of method 200 the groups of pixel data are reordered to conform to the read origin and spatial read sequence based on the values received from the request engine and previously applied to the rendered scene as a whole. It should be noted that the method of communicating the read origin and spatial read sequence may involve a different path to the appropriate components than what is outlined in the present description.

At 208 of method 200 the resequenced and reordered image data is stored in one or more line buffers depending on the format of the data. If the image data is grouped, the number of line buffers implemented would correspond to the number of partial lines included in each grouping of pixels. If a YUV color format is in use, the number of line buffers implemented would be multiplied by either two or three depending on the format in use.

At 209 of method 200 the appropriate line buffer writes its contents to display 120 in a FIFO sequence, resulting in the rendered scene appearing upright from the perspective of the user.

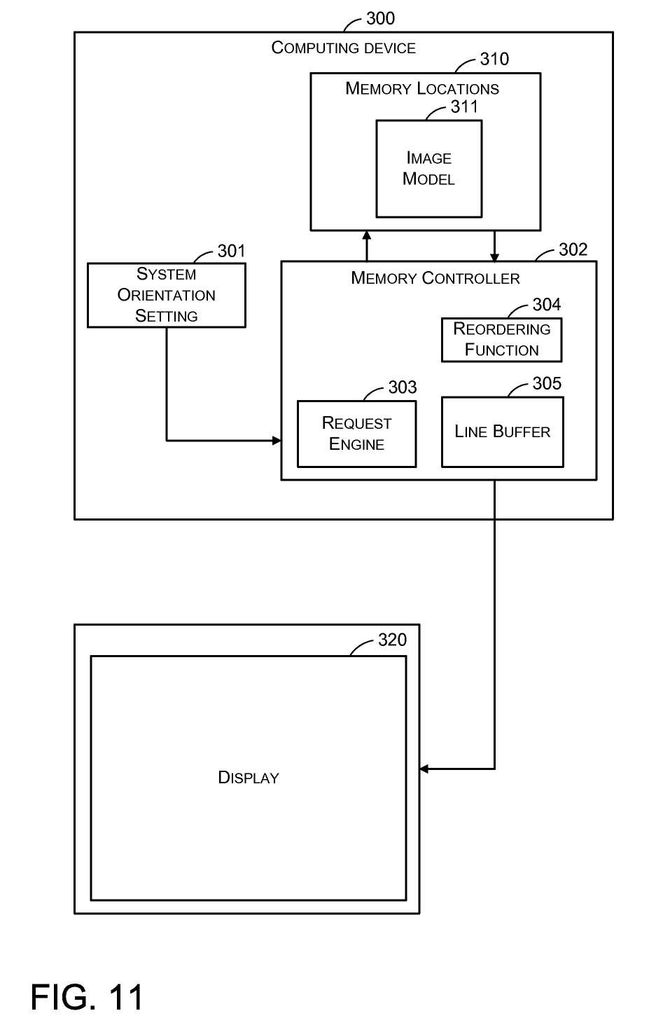

A second example of the present disclosure is shown in FIG. 11. The block diagram shows a computing device 300 including a system orientation setting 301 that plays the role of position sensor 101 from FIG. 1, but relies on software and/or user input to determine the correct orientation to display. The system as shown also includes peripheral display 320 that may be a desktop monitor, laptop screen, or any other appropriate display device and may have a portrait or landscape form factor. Request engine 303, reordering function 304 and line buffer 305 are integrated into memory controller 302, but otherwise operate as described in the previous example. Image model 311 in memory locations 310 is retrieved with a spatial read sequence corresponding to the information provided by the system setting, and written to the display in the designated orientation. It should be realized that while the example above focuses on mobile devices, the disclosure also applies to other electronic displays (e.g. desktop monitors). The electronic device is depicted as including specific sub-components, but it should be understood by that any selection and arrangement of components may be used to fetch image data from one or more storage locations according to a spatial read scanning sequence (e.g., row by row, column by column, etc.). It will be understood that the configurations and/or approaches described herein are exemplary in nature, and that these specific embodiments or examples are not to be considered in a limiting sense, because numerous variations are possible.

It will be appreciated that methods described herein are provided for illustrative purposes only and are not intended to be limiting. Accordingly, it will be appreciated that in some embodiments the methods described herein may include additional or alternative processes, while in some embodiments, the methods described herein may include some processes that may be reordered, performed in parallel or omitted without departing from the scope of the present disclosure. Further, it will be appreciated that the methods described herein may be performed using any suitable software and hardware in addition to or instead of the specific examples described herein. The subject matter of the present disclosure includes all novel and non-obvious combinations and sub-combinations of the various processes, systems and configurations, and other features, functions, acts, and/or properties disclosed herein, as well as any and all equivalents thereof.

1. A method of displaying content on an electronic device that can rotate displayed content in response to rotation of the electronic device, the method comprising:
storing a frame of image data in memory locations on the electronic device;
detecting an orientation of the electronic device; and
retrieving the image data from the memory locations in a spatial read sequence that is dependent upon the detected orientation of the device, such that when the electronic device is in a first orientation a first spatial read sequence from the memory locations is used, and when the electronic device is in a second orientation different than the first orientation a second spatial read sequence from the memory locations is used, wherein the second spatial read sequence is different than the first spatial read sequence.

2. The method of claim 1, where the retrieved image data is placed into a buffer in accordance with a writing scheme in which data is read out of the buffer and written line-by-line to a display of the electronic device.

3. The method of claim 2, where the retrieved image data is retrieved in blocks and ordered into a serial line-writing pixel sequence prior to placing it into the buffer.

4. The method of claim 3, where each block includes a portion of the frame of image data, each portion being composed of either: (a) multiple partial rows of the frame of image data or (b) multiple partial columns of the frame of image data.

5. The method of claim 3, where retrieving the image data includes retrieving the blocks row-by-row if the electronic device is in a first predetermined orientation, and column-by-column if the electronic device is in a second predetermined orientation.

6. The method of claim 1, where the retrieved image data is retrieved in blocks, each of which is a portion of the frame of image data.

7. The method of claim 6, where retrieval of image data is controlled in accordance with:
(1) a value that specifies whether retrieval is performed row-by-row or column-by-column; (2) a value that specifies whether retrieval begins at a topmost or bottommost portion of the frame of image data; and (3) a value that specifies whether retrieval begins at a leftmost or rightmost portion of the frame of image data.

8. The method of claim 1, where the frame of image data is encoded in RGB color space.

9. The method of claim 1, where the frame of image data is encoded in YUV color space.

10. The method of claim 1, where retrieving the image data includes retrieving the image data row-by-row if the electronic device is in a first predetermined orientation, and column-by-column if the electronic device is in a second predetermined orientation.

11. A method of displaying content on an electronic device that can rotate displayed content in response to rotation of the electronic device, the method comprising:
storing a frame of image data in memory locations on the electronic device such that the image data can be characterized as a matrix of rows and columns;
detecting an orientation of the electronic device; and
retrieving the image data row by row if the electronic device is in a first predetermined orientation, and column by column if the electronic device is in a second predetermined orientation which is different than the first predetermined orientation.

12. The method of claim 11, where (a) if a default orientation of the display is a portrait form factor, the first predetermined orientation is a portrait orientation relative to a user, and the second predetermined orientation is a landscape orientation relative to the user; and (b) if the default orientation of the display is a landscape form factor, the first predetermined orientation is a landscape orientation relative to the user, and the second predetermined orientation is a portrait orientation relative to the user.

13. The method of claim 11, where the spatial read sequence begins at a read origin that is associated with the detected orientation of the electronic device.

14. The method of claim 13, where retrieval and rendering is performed such that the read origin of the electronic device is relocated to correspond to the change in position of a write origin used to write data to a display of the electronic device.

15. The method of claim 11, where row-by-row retrieval is further controlled to specify whether retrieval begins with a topmost or bottommost portion of the frame of image data.

16. The method of claim 11, where column-by-column retrieval is further controlled to specify whether retrieval begins with a leftmost or rightmost portion of the frame of image data.

17. An electronic device configured to rotate displayed content in response to changes in orientation of the device, comprising:
a display;
a position sensor;
a frame of image data contained in memory locations of a data-holding system, the image data being usable to write lines to the display and thereby produce a viewable image;
an image data retrieval mechanism configured to retrieve the image data from the memory locations in a spatial read sequence that is dependent upon data collected by the position sensor, such that the spatial read sequence from the memory locations used for a first orientation of the electronic device is different than the spatial read sequence from the memory locations used for a second, different orientation of the device.

18. The electronic device of claim 17, where image data is retrieved row-by-row in the case of a first orientation of the electronic device, and column by column in the case of a second orientation of the device.

19. The electronic device of claim 17, where image data retrieval is controlled in accordance with: (1) a value that specifies whether retrieval is performed row-by-row or column-by-column; (2) a value that specifies whether retrieval begins at a topmost or bottommost portion of the frame of image data; and (3) a value that specifies whether retrieval beings at a leftmost or rightmost portion of the frame of image data.

20. The electronic device of claim 17, where image data is retrieved in blocks and is reordered prior to a line-by-line writing operation performed on the display of the electronic device.
